(19) United States
(12) Patent Application Publication
(10) Pub. No.: US 2010/0222917 A1
(43) Pub. Date: Sep. 2, 2010

(54) System and Method for Tagging Products for Use in Identification of the Components Therein

(76) Inventors: James W. BOHLIG, Rutland, VT (US); Douglas R. CASELLA, Mendon, VT (US)

Correspondence Address: WILMERHALE/BOSTON, 60 STATE STREET, BOSTON, MA, 02109, US

(21) Appl. No.: 12/565,962

(22) Filed: Sep. 24, 2009

Related U.S. Application Data
(60) Provisional application No. 61/100,038, filed on Sep. 25, 2008.

(51) Int. Cl. G06F 7/00; G06K 7/10; B07C 5/34; B07C 5/342

(52) U.S. Cl. 700/224; 235/375; 209/10

(57) ABSTRACT

The present invention provides a system and method for tagging complex products for use in the identification and, optionally, segregation of the components therein. In particular, the present invention provides techniques for identifying products included in a mixed waste stream based on its product type or on the materials of which the product is comprised. According to the system and method of the present invention, if the product type or its material of construction are designated for removal from the mixed waste stream, the product is segregated, thereby enabling exclusion of such products and materials from an optimum fuel created from the remaining items in the mixed waste stream.

### CROSS REFERENCE TO RELATED APPLICATIONS

This application claims the benefit under 35 U.S.C. §119(e) of U.S. Provisional Patent Application No. 61/100,038, filed on Sep. 25, 2008, entitled System And Method For Tagging Products For Use In Identification Of The Components Therein, which is herein incorporated by reference in its entirety.

### FIELD OF THE INVENTION

The present invention generally relates to separation of items. More particularly, the present invention is concerned with the identification of certain types of items in a mixed items stream.

### BACKGROUND OF THE INVENTION

Disposal of waste streams composed of mixed items is a recognized problem in The United States and abroad. Methods for separating a mixed waste stream into its component parts have been proposed. In theory, the separated items can then be reused, recycled, or put to another productive use rather than the items entering a landfill. However, contamination by certain separated items remains an unsolved problem and prevents the optimal reuse or recycling of some items.

For example, one approach to treating a mixed waste stream is to separate plastic products from the waste stream for recycling. However, if even small amounts of metal are included in the separated plastic products, the contaminated collection of plastics may be unfit for reuse as a feedstock for new plastic products. Furthermore, it is often difficult to determine the composition of materials in the waste stream. Another alternative to sending items to a landfill is to recover energy stored within certain components of a mixed waste stream.

Combustion and gasification are thermochemical processes that are used to release the energy stored within the fuel source. Combustion takes place in a reactor in the presence of air, or at least an excess of oxygen. Combustion is generally used for generating steam, which in turn is used to generate electricity through turbines. However, the brute force nature of complete combustion of fuel causes significant amounts of pollutants to be generated in the gas given off during combustion. For example, combustion in an oxygen atmosphere of, for example, coal releases nitrogen oxides, a precursor to ground level ozone, which can stimulate asthma attacks. Combustion is also the largest source of sulfur dioxide, which in turn produces sulfates that are very fine particulates. Fine particle pollution from U.S. power plants cuts short the lives of over 30,000 people each year. Hundreds of thousands of Americans suffer from asthma attacks, cardiac problems and upper and lower respiratory problems associated with fine particles from power plants.

Gasification also takes place in a reactor, although in the absence of air, or in the presence of substochiometric amounts of oxygen. The thermochemical reactions that take place in the absence of oxygen or under substochiometric amounts of oxygen do not result in the formation of nitrogen oxides or sulfur oxides.

A variety of gasifier types have been developed. They can be grouped into four major classifications: fixed-bed updraft, fixed-bed downdraft, bubbling fluidized-bed and circulating fluidized bed. Differentiation is based on the means of supporting the fuel source in the reactor vessel, the direction of flow of both the fuel and oxidant, and the way heat is supplied to the reactor.

Normally these gasifiers use a homogeneous source of fuel because a constant unchanging fuel source allows the gasifier to be calibrated which allows a desired product to be formed. Common types of fuel used today in gasifiers are wood, coal, petroleum, and, biomass. Since some of these fuel sources are becoming increasingly more expensive, energy and petrochemical suppliers are seeking alternative fuel feed stocks. It has been proposed that certain components of mixed waste streams (e.g., municipal solid waste, industrial/commercial waste, mixed recyclable materials, and/or construction and demolition debris), can be used as a fuel feed stock for a gasifier.

However, municipal solid waste often contains contaminating items constructed of materials that can cause problems in a gasification process and/or subsequent downstream processes. These same items can also be harmful to the environment if incinerated. For example, many electronics goods eventually find their way into municipal solid waste streams contain lead, mercury, and/or other potentially toxic materials. In addition, some of the contaminating items in the mixed waste stream may contain valuable materials that are desirable to extract from the items. As with the example above, some electronics goods contain small amounts of precious metals, such as copper, nickel, tin, and tungsten. Thus, it is desirable to remove such items and materials from the waste streams before incineration or gasification of the waste. Moreover, small electronic devices are often especially difficult to identify in and remove from a mixed waste stream. For example, mobile telephones, batteries, and small computerized devices can become buried among other waste in a picking line.

The problem of hidden hazardous materials is further compounded by the fact that often the hazardous materials are incorporated deep within an item included in the mixed waste stream. Mobile telephones provide a good example of this problem. The outer shell of a mobile telephone is typically plastic, glass, and/or metal. However, the printed circuit boards, electronic components, and batteries are hidden within the outer shell and contain hazardous materials, as mentioned above.

Thus, it is an object of the invention to provide techniques for tagging certain contaminating and/or problematic products made with hazardous and/or valuable materials in a mixed waste stream and subsequently identifying those products. Once identified, the products can be removed from the mixed waste stream. In addition, a composition of the mixed waste stream can be determined from the identities of its constituent parts. Therefore, the techniques disclosed herein can be used to produce alternative fuels that burn efficiently and cleanly, are devoid of hazardous or other harmful materials, and that can be used for the production of energy and/or petrochemicals.

It is also an object of this invention to provide an improved and economical process to dispose of a mixed waste stream by recovering the energy bound within it and reducing the need for fossil fuels. It is another object of this invention to provide an information processing system for receiving information associated with tags that have been incorporated in or on products.

It is a further object of this invention to identify and eliminate hazardous materials, valuable materials, and complex items containing hazardous and/or valuable materials from a mixed waste stream to prevent the materials and items from entering a gasification process. It is further still an object of this invention to recover valuable and/or precious materials from a mixed waste stream before incineration, gasification, or disposal of the remaining items in the waste stream.

### SUMMARY OF THE INVENTION

Under one aspect of the invention, a system and method for tagging products for use in identification of the components therein is provided.

Under another aspect of the invention, a method of estimating a composition of a heterogeneous mix of products includes receiving a heterogeneous mix of products including a plurality of types of products. Each product contains a corresponding at least one material. At least a plurality of the products each include a product tag associated with information about the product. The information including at least information describing the corresponding at least one material. The method also includes scanning the mix of products to detect the tags included with the plurality of products and retrieving the information describing the corresponding at least one material of the products that include tags detected during the scanning of said mix. The method further includes estimating a total quantity of a selected material present in the heterogeneous mix of products based on the retrieved information describing the corresponding at least one material of the products that include tags detected during the scanning of said mix.

Under yet another aspect of the invention, the method above further includes, subsequent to scanning the mix of products, processing the heterogeneous mix of products in a sorting system. At least a portion of the products being separated from the heterogeneous mix of products, and, subsequent to separating the at least a portion of the products from the heterogeneous mix of products, scanning said separated portion to detect the tags included with the products of said separated portion. The method also includes retrieving the information describing the corresponding at least one material of the products that include tags detected during the subsequent scanning of said separated portion and estimating a second quantity of the selected material present in said separated portion based on said retrieved information describing the corresponding at least one material of the products that include tags detected during the subsequent scanning of said separated portion.

Under a further aspect of the invention, a method of sorting a heterogeneous mix of products includes receiving a heterogeneous mix of products; at least a plurality of the products each include a product tag associated with information about the product. The product tag includes a compound that emits light of a predetermined range of wavelengths when exposed to a light source. The method also includes scanning the mix of products to detect the tags included with the plurality of products, and sorting at least a portion of the plurality of products based on at least one of the product tags and information associated with the tags.

Under yet a further aspect of the invention, the above method also includes providing a catalog of tags. Each tag is associated with a corresponding material type. The method also includes, for each detected tag, retrieving from the catalog the material type corresponding to the detected tag. The sorting at least a portion of the plurality of products being based on the material types corresponding to the detected tags.

Under still another aspect of the invention, a method of tagging material for use in making products includes receiving a heterogeneous mix of products. Each product contains a corresponding at least one material. The method also includes sorting at least a portion of the plurality of products into groups based on the corresponding at least one material contained in the products. Each group has products that include a predetermined material. The method further includes mixing a tagging agent with at least one of the groups of sorted products based on the predetermined material of the group so that the tagging agent distinguishes the material contained in the products of the at least one group from other materials.

Under still a further aspect of the invention, the method above also includes providing a catalog of a plurality of tagging agents, and recording, in the catalog, an association between the predetermined material of the group of sorted products and information identifying the tagging agent mixed with the group of sorted products.

Under an aspect of the invention, a method of determining the composition of a product includes receiving a product. The product includes more than one component, and each component has a component tag identifying the component. The method also includes scanning the product to detect the component tags included in the product, retrieving information describing the components associated with the detected tags, and estimating the composition of the product based on the information describing the components associated with the detected tags.

### BRIEF DESCRIPTION OF DRAWINGS

FIGS. 1a, 1b, and 1c show an exemplary process for separating and sorting waste items.

FIG. 2 shows a flow diagram for segregating products that have been tagged with a material that reflects a predetermined wavelength of light.

FIG. 3 shows a flow diagram for identifying products that have been tagged and supplying information about the tagged products to an information processing system.

### DETAILED DESCRIPTION

Embodiments of the invention provide for identifying tagged products contained within a heterogeneous mix of products. Some embodiments further provide for the separation and sorting of the products based on their identification. While these embodiments may be used with a variety of heterogeneous product mixes, an illustrative embodiment includes a process for identifying tagged products in a mixed waste stream, e.g., a municipal waste stream, mixed materials resulting from automotive recycling operations, single stream recycling mixed materials, etc. Optionally, the products may then be sorted according to their identification. The waste stream to be sorted may contain products that include materials or are constructed of materials that are desirable to remove from the combined waste stream. For example, the products may contain hazardous materials (e.g., materials that are corrosive, toxic, ignitable, and/or reactive), and/or the products may contain materials that are desirable to segregate early in the process because of the value of the materials (e.g., precious metals). These hazardous or valuable materials may be embedded within the products, i.e., not readily apparent from the exterior. Moreover, the products may be of heterogeneous construction (i.e., composed of various types of the materials). One illustrative example is a mobile telephone.

A mobile telephone is typically composed of plastic, metal, circuit board materials, and a battery. Thus, the mobile telephone is of heterogeneous construction and may contain one or more hazardous materials. Therefore, it is desirable to segregate any mobile telephones from the mixed waste stream before the remaining waste stream is further processed and separated according to various material types. Other illustrative products include personal digital assistants (PDAs), computer components, small electronic devices, non-recyclable batteries for consumer devices, car batteries, and used diapers. Identification and segregation of products containing hazardous materials allow the remainder of the mixed stream to be put to beneficial use, e.g., the products remaining in the stream can be incinerated to produce electricity, or the remaining products can be gasified, as set forth in more detail below.

Implementations of the invention also provide for the identification and separation of products that are homogenous in nature. Such products may or may not be considered hazardous or of high value. For example, the systems and methods disclosed herein may be used to separate recyclable products from a mixed municipal waste stream. Thus, all products of one type can be separated from products of a different type.

As mentioned above, separating products based on their identification is an optional aspect of the invention. Embodiments can be used to identify tagged products in a heterogeneous mix of products in order to determine, at least in part, the composition of the mixed stream. This composition information can be used for various purposes, as set forth in greater detail below.

As used herein, the term “product” generally refers to a physical item or assembly of items. Products can include finished goods, packaging, and/or portions thereof. One product can be included within another product or be a portion of another product. For example, a mobile telephone is a product that contains another product, namely, a battery. Furthermore, products include the packaging for another product. For example, a box which contained a mobile telephone is a product. Further still, products include containers within which other products or materials are contained. For example, a plastic bottle containing a liquid substance is a product.

As used herein, the term “material” generally refers to a substance used to construct a product, a substance contained in a product, a substance that has become attached to a product, or a substance that is otherwise part of a product. Materials include, e.g., the outer casing of a product, the inner components of a product, or substances that have come into contact with a product and have adhered to the product. Some materials can be relatively benign; for example, a propane tank is constructed from steel. While other materials can be hazardous; for example, the propane contained within the propane tank is explosive.

In accordance with an embodiment of the invention, a product is marked according to its materials of construction and/or materials contained therein at the time of its construction or before the product enters the waste stream. In certain implementations, the product can be tagged at the time of its construction or before the product enters the waste stream with a chemical marker. Such a marker includes an agent that reflects or emits a predetermined wavelength of light when illuminated. For example, the product may be coated with such an agent, or an agent may be incorporated into one or more of the materials of which the product is constructed. In certain embodiments, the wavelengths of light reflected by the agent are invisible to the human eye, i.e., above or below the visible portion of the electromagnetic spectrum. For example, an ultraviolet-reflective paint, which is clear in the visible spectrum, can be applied to the exterior of a product. Because the paint is clear with respect to the visible spectrum, the aesthetic design of the product is unaffected by the application of the paint. However, upon exposure to a predetermined wavelength of ultraviolet (UV) light, the product will appear to glow brightly in a particular range of wavelengths.

Other suitable agents are materials that are substantially invisible in regular light, but are fluorescent in the visible spectrum under, for example, black light. For example, DFSB-C0 Clear Blue Fluorescent Dye (available from Risk Reactor of Dallas, Oreg.) is essentially invisible in regular lighting conditions (i.e., typical ambient lighting levels), but has a peak fluorescence of 435 nm (blue) upon exposure to “black light” (i.e., electromagnetic radiation including wavelengths in the near ultraviolet range, e.g., 375 nm peak 20 nm wide.) In contrast, DFSB-C7 Clear Red Fluorescent Dye (also available from Risk Reactor) is also clear under regular light, but fluoresces in the red range of the visible spectrum when exposed to black light. Thus, while both of these dyes appear invisible in normal lighting conditions, the dyes, and products containing the dyes, can be distinguished upon illumination with black light. Further still, a tagging agent that can be designed to reflect or emit light of a particular wavelength includes quantum dots (commercially available from Evident Technologies of Troy, N.Y.). Quantum dots possess unique optical and electronic properties that enable their emission frequencies to be finely tuned to a desired wavelength.

Thus, light sources that emit the predetermined wavelength of UV light and optical sensors that are designed to detect the predetermined wavelength of reflected UV light can be included in a waste separating and sorting system to detect and identify products in the waste stream that are tagged with the UV-reflective paint. After identification, the products can be segregated from the waste stream, or the identity of the product can be used in further separation and sorting processes.

Similarly, in other implementations, a UV-reflective pigment is included in the material used to construct the product, or at least the outer casing of the product. Thus, as with the UV-reflective coating, the casing itself would appear to glow brightly when illuminated with a light of a predetermined wavelength without affecting the aesthetics of the product. Although the examples given above refer to a UV-reflective coating or pigment, agents that reflect or emit other portions of the spectrum may be used to tag products, including those below the visible spectrum, within the visible spectrum, and/or above the visible spectrum. Likewise, agents that emit a particular wavelength of light when illuminated by a light source having a wavelength that differs from the particular wavelength of light are within the scope of the invention. For example, phosphorescent pigments may be employed in coatings applied to the product or added to the materials of construction of the product.

Moreover, although embodiments disclosed herein are described in terms of emitting or reflecting light, tagging agents that emit or reflect other portions of the electromagnetic spectrum may be used and remain within the scope of the invention. For example, certain agents that emit unique spectral signatures in the x-ray range may be used as tags for products. In such an embodiment, the product is irradiated with x-ray or gamma ray energy, and secondary x-rays are emitted from tagged products. Examples of agents that can be used as tags in such embodiments are disclosed in U.S. Pat. Nos. 5,474,937, 5,760,394, and 6,025,200, incorporated by reference herein. In addition, other ranges of wavelengths of light are within the scope of the invention.

The examples of coating, pigments, dyes, and/or other agents provided above are merely illustrative in nature, and the scope of the invention encompasses other materials that emit or reflect a range of wavelengths of light suitable for use as optical tags. Table 1 provides further illustrative examples of materials that can be used as optical tags and includes the ranges of wavelengths (or peak wavelength) emitted or reflected by the particular tags. Table 1 also provides examples of the ranges of wavelengths (or peak wavelength) used to cause the optical tags to emit or reflect the range of wavelengths associated with the particular tag. Sources for light of various wavelengths are known in the art, and can include, for example, traditional fluorescent lamps, traditional incandescent lamps, mercury vapor lamps, xenon arc lamps, mercury-xenon arc lamps, metal-halide arc lamps, tungsten-halogen incandescent lamps, mineral far infrared lamps, and/or other light sources.

TABLE 1
Illustrative materials for use as optical tagging agents

| | | Emitted or |
|---|---|---|
| | Wavelengths of | reflected |
| Material | illumination source (nm) | wavelengths (nm) |
| Y₂O₃:Eu | 254 | 611 |
| CeMgL₁₁O₁₉:Tb | 254 | 525 |
| BaMgAl₁₀O₁₇:Eu | 370-420 | 450 |
| BaMgAl₁₀O₁₇:Eu²⁺Mn²⁺ | 370-420 | 515 |
| Aminocoumarin | 350 | 445 |
| Allophycicyanin | 650 | 661 |
| Alexa488 | 495 | 519 |
| CY3 | 554 | 568 |
| CY5 | 649 | 666 |
| Fluorescein | 494 | 518 |
| Fluorescein isothiocyanate | 490 | 525 |
| (PITC) | | |
| Fluo 3 | 485 | 503 |
| (Hex)5-hexachloro- | 535 | 553 |
| fluorescein | | |
| JOE | 528 | 554 |
| Sybr Green I | 494 | 521 |
| (ROX)6-carboxy-x- | 587 | 607 |
| rhodamine | | |
| (TAMRA)tetramethyl-6- | 560 | 582 |
| carboxyrhodamine | | |
| (TET)5-tetrachloro- | 521 | 538 |
| fluorescein | | |
| Texas Red | 596 | 615 |
| VIC | 538 | 554 |

As described herein, the optical tagging agents, including those listed in Table 1, may be incorporated into portions of the products to be tagged. Likewise, the tagging agents may be applied in a coating on the external surface of the products to be tagged. Thus, for example, a tagging agent can be incorporated into a plastic material that comprises a portion of the outer shell of a product during a plastic molding process. In the alternative, in a post-manufacturing step, a coating including an optical tag can be applied to a portion of the external surface of the product.

In some embodiments, the tagging agents are heat and/or chemically sensitive such that the tag is deactivated or changed when exposed to heat and/or chemical treatment. In this way, products containing hazardous materials or products that have come into contact with hazardous materials that can be made safe by heat or chemical treatment are tagged with an agent that responds to the treatment. Thus, when products tagged in this manner are read with optical tag readers, the tag is only detected if the product is still hazardous. In the alternative, the tag is changed in such a way so as to indicate that the product has been treated. For example, a product can be coated with an agent that reflects a first wavelength of ultraviolet light when illuminated by a reader. After the product is heat-treated, e.g., to eliminate any biological contaminates, the coating changes such that it reflects a second wavelength of ultraviolet light different from the first. In this way, it can be known that the product has been heat-treated to render it harmless. In certain embodiments, a container, such as a disposable plastic bag, can be tagged in this manner.

As mentioned generally above, products are tagged during manufacture or, otherwise, before the product enters a waste stream. Product manufacturers can include the tags in or on products during the manufacturing process or shortly thereafter. In some embodiments, an optical tag is added to the casing of a product. This can take the form of an agent that reflects or emits certain wavelengths of light, as described generally above. Manufacturers of products so tagged can add the agent to the raw material from which the product or its casing are made. Thus, when the final product is made, its casing can be detected by the optical tag readers. For example, a manufacturer of polyethylene terepthalate (PET) plastic bottles can include a tagging agent in the virgin PET polymer before the bottles are molded. Optical tag readers may then detect the bottles made from the combined tagging agent and PET polymer.

In yet further embodiments, a tagging agent is added to a quantity of recovered material that is to be recycled. A process for separating and sorting waste products is described in greater detail below. Embodiments of this process recover products to be recycled according to the type of material of which the products are made. After a quantity of products made of a certain type of material are recovered, the products are further processed in preparation for the material to be recycled. During the further processing, the tagging agent is added to the material. For example, PET plastic bottles are separated from a mixed waste stream according to a process described below. After the PET bottles have been collected, the bottles are shredded into PET “flakes”. During the shredding process, an optical tagging agent is added to the PET material. The material, which now includes the tagging agent, is then conveyed to a PET plastic bottle manufacturer for reuse during bottle production. In this way, the optical tag is introduced into PET plastic bottles without the need for intervention on the part of the bottle manufacturer.

As described herein, in certain implementations, the particular range of wavelengths of light (or other portions of the electromagnetic spectrum) emitted or reflected by the tagging agent is varied to correspond to one or more materials in a product in which the tagging agent is included. In other implementations, the range of wavelengths emitted or reflected by the tagging agency does not vary according to material. Rather, the intensity or strength of reflected or emitted electromagnetic energy is varied according to a material in the product in which the tagging agent is included.

As described herein, embodiments of the invention enable the identification of products for use in improved sorting and separation of the various materials and products contained in mixed waste streams. In addition, embodiments of the invention enable certain types of products to be segregated from the mixed waste products before the materials included in or comprising the product contaminate the remaining waste items.

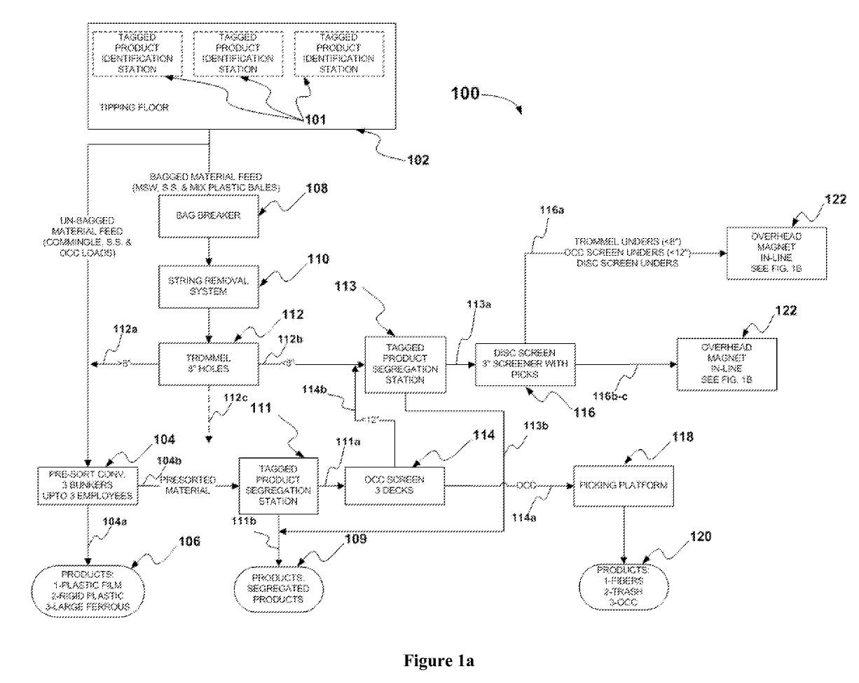

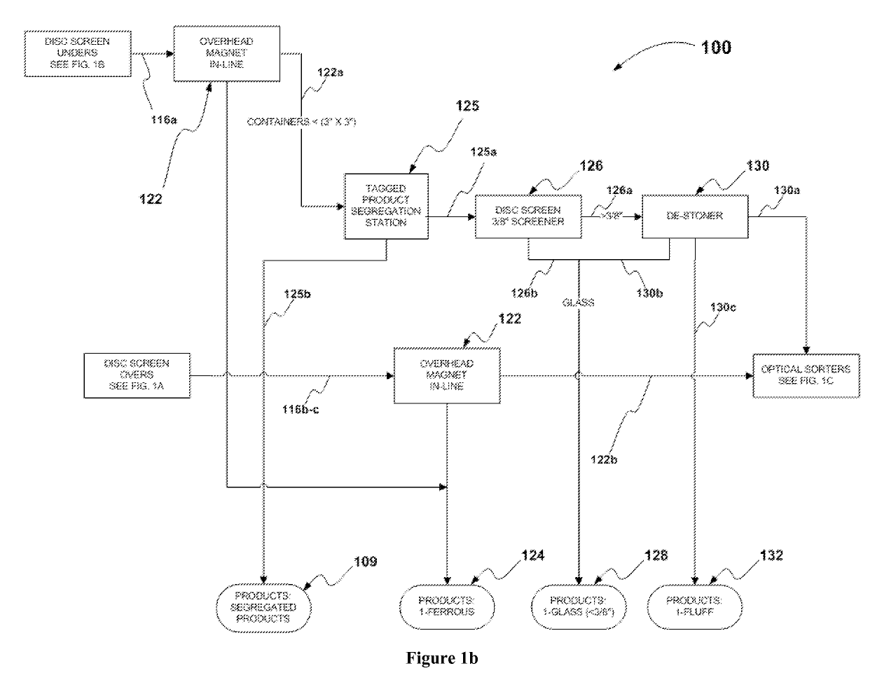

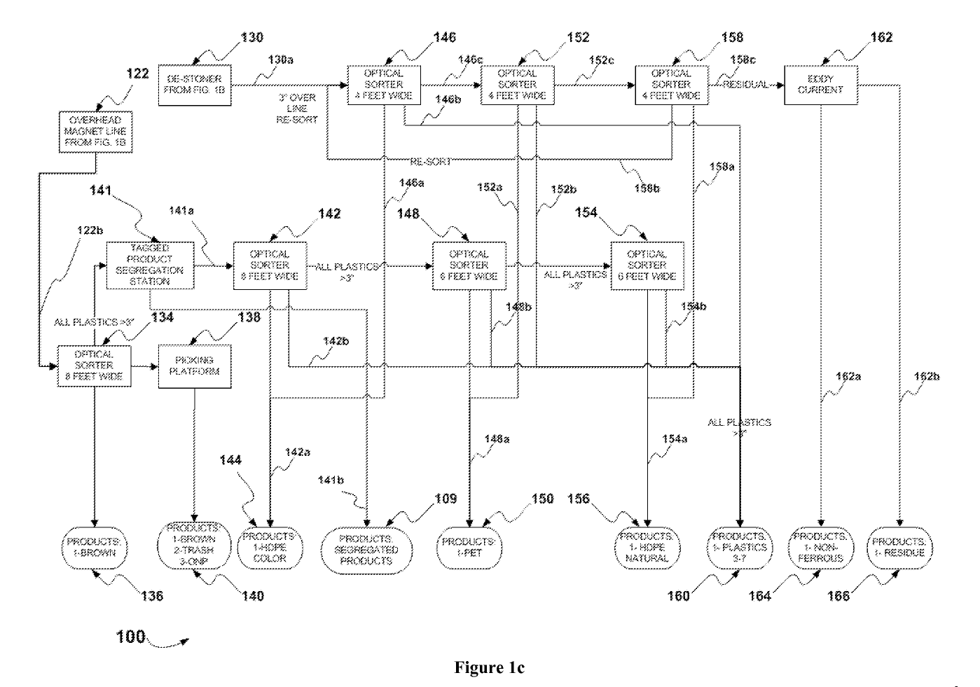

Referring now to the drawings, and more particularly, to FIGS. 1a, 1b, and 1c, generally at 100, there is shown an exemplary process for separating and sorting waste items. Each collection of sorted waste items can, for example, be reused or recycled, or the items may be formulated into a feedstock for gasification process and eventual production of engineered fuels (e.g., using such processes as those described in U.S. patent application Ser. No. 12/491,650, entitled System and Method for Integrated Waste Storage, filed Jun. 25, 2009, U.S. patent application Ser. No. 12/492,096 entitled Engineered Fuel Feed Stock, filed Jun. 25, 2009, and U.S. patent application Ser. No. 12/492,093 entitled Engineered Fuel Feed Stock Useful for Displacement of Coal in Coal Firing Plants, filed Jun. 25, 2009, each of which is incorporated by reference herein.) Waste items are brought into a large reception area by waste collection vehicles as either single stream or as multiple streams. The waste streams may be bagged, unbagged, or a construction and demolition (C&D) stream. Unbagged waste items include, for example, commingled waste items, single stream waste items and old corrugated cardboards (OCC). Unbagged and bagged waste items may include products, which have been tagged as described above, that are desirable to identify and, optionally, segregate from the remaining mixed waste stream at various stages in the separation process. Waste items are dumped on a tipping floor 102 and are then pushed onto a conveyor by a payloader.

Tipping floor 102 can be equipped with one or more tagged product identification stations 101. Tagged product identification stations 101 identify products that have been tagged with an agent that emits or reflects a predetermined wavelength of light (“optically tagged”), as set forth generally above. Thus, before any of the waste items are further processed in sorting and separation process 100, tagged products are identified while still on tipping floor 102. This enables the approximate composition of the dumped items to be determined. In addition, certain materials and/or products can be segregated while still on the tipping floor 102. For example, if the product identification stations 101 determine that a particular load of waste that has been dumped contains hazardous materials, that load can be segregated for special treatment rather than being pushed onto the conveyor mentioned above.

In one embodiment, unbagged waste items are presorted by customers. In another embodiment, unbagged waste items are presorted by collection service at customer sites. From tipping floor 102, unbagged waste items are transferred to presorting station 104 by the conveyor. Presorting station 104 sorts the unbagged waste items into large ferrous, large plastic (e.g., large hard plastics), and plastic film substreams. Each of the substreams from presorting station 104 is further subdivided into two streams 104a and 104b. Clean and sorted waste items from presorting station 104 are included in first stream 104a, and are then transferred to bunker 106. In one embodiment, bunkers 106 may include compartments designated for each of the items in the first stream 104a.

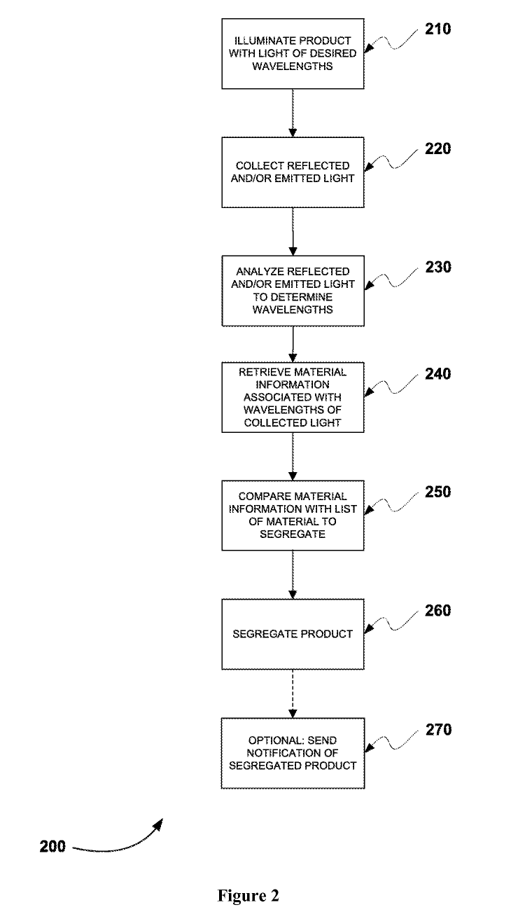

Sorted waste items, including contaminants, from presorting station 104 are diverted as second stream 104b to tagged product segregation station 111. Tagged product segregation station 111 identifies products that have been tagged and removes those products from the waste stream, as set forth generally above and described in greater detail below in connection with FIG. 2. Segregated products are diverted to segregated product bunker 109. In addition to segregating the tagged products, tagged product segregation station 111 provides the identification information to an information processing system for tracking the composition of the waste passing through processing system 100. Items passing through tagged product segregation station 111 pass via stream 111a to OCC screen 114. OCC screen 114 screens out, for example, paper, bags, and corrugated fiber from stream 104b. In one aspect of the present invention, OCC screen 114 is an OCC disc screen, which includes multiple discs that rotate and impart, for example, a wavelike motion that causes larger objects such as OCC to move upwards, away from the remainder of stream 104b. In some embodiments, OCC screen 114 will be utilized to remove mixed and office paper from OCC. OCC screen 114 can utilize, for example, serrated elliptical disks made out of ½-inch thick steel plate. The size of the disks can be changed, and the space between disks or rows of disks can be varied to adapt to the stream of waste items. In one embodiment, OCC screen 114 includes three decks for removing OCC fibers, non-OCC fibers, and containers that are sized at about 8 inches by 12 inches. Negatively sorted OCC stream 114a from OCC screen 114 are transferred to picking platform 118, where fiber shreds and trash are removed from OCC stream 114a. Fiber shreds, trash, and OCC from picking platform 118 are then transferred to bunkers 120.

If the waste from tipping floor comprises bagged waste items, the conveyor carries the bagged waste items for bag breaking/splitting. Before transferring the items for bag splitting, the items may be weighed using a scale. A bag splitter 108 tears the bags open and transfers the waste items to other units in the process for separation and sorting. Each unit in the process removes a particular type of material or product from the waste items.

First, the items from bag breaker 108 are transferred to a stringer screening unit 110. The stringer screening unit 110 removes long strands (e.g., threads, strings, wires, tapes, ropes, etc.) that could damage downstream equipment. After removing strings, waste items are transferred to trommel 112, where oversized items are removed to prevent damage of downstream sorting equipment. A trommel is a rotating cylindrical screen that is inclined at a downward angle from a horizontal axis. For example, the cylindrical screen may include 8 inch holes, which allows items that are less than 8 inches to fall through while retaining items larger than 8 inches within the cylinder. Items are fed into a trommel at the elevated end, and separation occurs while the items move down the drum. The tumbling action of the trommel separates items that may be attached to each other. In one embodiment of the present invention, sorting process may be rearranged such that bagged waste items are directly fed into a trommel with picks. Trommel picks may be attached to the insides of the cylindrical screen, and may be used to gently open bags and then disperse the items without resizing the items. Sorted waste items from the trommel are then passed through a stringer unit to remove the strings from the waste items.

Negatively sorted stream 112a (e.g., trommel overs greater than 8 inches) from trommel screen 112 are mixed with unbagged waste items from tipping floor 102, and then provided as input to presorting station 104. For example, negatively sorted stream 112a may include items that are greater than 8 inches and have high fiber content. Positively sorted stream 112b (e.g., trommel unders less than 8 inches) from trommel screen 112 are mixed with positively sorted stream 114b (e.g., OCC screen unders) from OCC screen 114, and then provided as input to tagged product segregation station 113. As with station 111, tagged product segregation station 113 identifies and removes products that have been tagged. Tagged product segregation station 113 also provides identification information to the information processing system. Trommel screen 112 can also be configured to produce a third stream 112c that contains items and products of an intermediate size. In such an embodiment, the negatively sorted stream 112a contains items sized greater than, for example, 12 inches; the intermediate stream 112c contains items sized between 12 inches and four inches, and the positively sorted stream 112b contains items sized less than four inches. These sized are merely illustrative, and other sizes and additional intermediate streams are within the scope of the invention. Segregated products are diverted to segregated products bunker 109, or, optionally, can be diverted to a separate segregated products bunker (not shown). Items passing through tagged product segregation station 113 pass via stream 113a to disc screen 116.

Disc screen 116 sorts containers from fibers in input stream 114b, and divides the sorted items into output streams 116a-c. In one embodiment, disc screen 116 is similar to OCC screen 114 but with smaller gaps between the discs. For example, disc screen 116 may include discs with gaps between them to allow container sizes smaller than about 2.5 inches by 3 inches to fall through. Output stream 116a from disc screen is provided as input to overhead magnet line 122. Output stream 116a may include trommel unders, OCC screen unders, majority of glass items, and containers that fall through the gaps between the discs in disc screen 116.

Positively sorted output stream 116a is provided as input to overhead magnet line 122 to separate ferrous metals from output stream 116a. Negatively sorted items may be further divided into dual line output streams 116b-c is also provided as input to overhead magnet line 122 to separate ferrous metals from output stream 116b. Output streams 116a-c reduce burden depth, increase recovery, and reduce contamination levels. Overhead magnet line 122 includes a belt magnet suspended above a conveyor to pick up ferrous items and transfer them onto a conveyor, which deposits the ferrous items into a ferrous storage bunker 124. Remaining waste stream of nonferrous items from overhead magnet line 122 is split into substreams 122a-b.

First substream 122a may comprise bulk light items, predominantly broken particles of glass, and plastics and non-ferrous containers of size less than about 3 inches by 3 inches. Substream 122a is provided as input to tagged product segregation station 125, which is similar to the tagged product segregation stations mentioned above. Segregated products are diverted to segregated products bunker 109, or, optionally, can be diverted to a separate segregated products bunker (not shown). Items passing through tagged product segregation station 125 pass via stream 125a to disc screen 126 to break and separate glass from plastics. In one embodiment, disc screen 126 separates particles less than ⅜ inches from the substream 122a. Separated glass particles from disc screen 126 are stored in bunker 128. Disc screen overs 126a comprising predominantly plastics, light fibers, and related airborne enabled material (generally “light material”) are provided as input to de-stoner 130 (e.g., vibrating air classifier) for separating more dense items such as glass and light material from the plastics. The waste items travel across a vibrating screen of de-stoner 130 and denser items such as the glass and light material fall through openings in the screen while the remaining lighter items are maintained above the screen by air supplied from a fan. Output stream 130b comprising separated glass from de-stoner 130 are mixed with glass particles in output stream 126b, and then transported to storage bunker 128. Output stream 130c comprising separated light material fall from de-stoner 130 are transported to storage bunker 132. Remaining output stream 130a from de-stoner 130 are provided as input to optical sorter 146 (FIG. 1b).

Second substream 122b, comprising predominantly fiber and reduced levels of plastics, is provided as input to optical sorter 134. Optical sorter 134 is used to remove all plastics from fiber browns. Optical sorter 134 shines light onto the conveyor, and a sensor detects the reflected light from plastic products. Using this information, the sensor locates the plastic product, targets a jet of air to hit the plastic product at the location, and removes it from the conveyor. Optical sorter 134 (and/or any of the other optical sorters disclosed herein) can also utilize any optical tags included in the products or other items passing through the optical sorter 134. For example, in addition to using the visible spectrum to distinguish plastics from fiber browns, optical sorter 134 can also shine lights of predetermined wavelengths to illuminate tagging agents included in the products passing through the sorter for the purpose of enabling identification of the materials of which the products are comprised. Any of the optical sorters can supply product information to the information processing system. In one embodiment, optical sorter 134 is capable of detecting plastic materials on an eight feet wide conveyor. Remaining stream from optical sorter 134, predominantly comprising fibers, is divided into fiber browns and remaining fibers. Removed fiber browns are stored in bunker 136, and the remaining fibers are provided as input to picking platform 138, where browns, old newspaper (ONP), plastics and trash are removed. In one embodiment, remaining fibers are provided as dual line input to picking platform 138. Browns, ONP, and trash from picking platform 138 are then transferred to bunkers 140.

Next, a cascading set of optical sorters are used to sort plastics of different colors and sizes. Sensors in this cascading set of optical sorters are capable of identifying plastics of different colors and sizes. Ejected plastics larger than a predetermined size, from optical sorter 134, are provided as input to optical sorter 142, first passing through optional tagged product segregation station 141. Tagged product segregation station 141 is included here as an illustrative example of how the segregation stations can be incorporated into the cascading set of optical sorters. Other tagged product segregation stations (not shown) may be included between other optical sorters of the cascading set of optical sorters, as desired, to segregate various products according to tags included in or on the products and to provide identification information to the information processing system. Segregated products are diverted to segregated products bunker 109 (or other bunkers, not shown).

Ejected plastics larger than 3 inches, for example, are provided as input to optical sorter 142. Optical sorter 142 detects and removes high density polyethylene (HDPE) color plastics from stream. In one embodiment, optical sorter 142 is capable of detecting HDPE color on an eight feet wide conveyor. Output stream 142a comprising ejected HDPE color plastics are transferred to bunker 144 for storage. In the remaining plastics, optical sorter 142 detects plastics of a predetermined size and ejects the detected plastics in a downward trajectory. In one example, sorted plastics smaller than 3 inches are ejected in a downward trajectory. In another example, sorted plastics from about 3 inches to about 7 inches are ejected in a downward trajectory. Output stream 142b comprising ejected plastics of the predetermined size are then transported to bunker 160 for storage. All remaining plastics larger than the predetermined size are provided as input to optical sorter 148.

Optical sorter 148 detects and removes PET plastics from the stream. In one embodiment, optical sorter 148 is capable of detecting PET on a six feet wide conveyor. Output stream 148a comprising ejected PET plastics are transferred to bunker 150 for storage. In the remaining plastics, optical sorter 148 detects plastics of a predetermined size and ejects the detected plastics in a downward trajectory. In one example, sorted plastics smaller than 3 inches are ejected in a downward trajectory. In another example, sorted plastics from about 3 inches to about 7 inches are ejected in a downward trajectory. Output stream 148b comprising ejected plastics of the predetermined size are mixed with output stream 142b, and then transported to bunker 160 for storage. Remaining plastics larger than the predetermined size are provided as input to optical sorter 154.

Optical sorter 154 detects and removes all HDPE natural plastics from the stream. In one embodiment, optical sorter 154 is capable of detecting HDPE natural on a six feet wide conveyor. Output stream 154a comprising ejected HDPE natural plastics are transferred to bunker 156 for storage. In the remaining plastics, optical sorter 154 detects plastics of a predetermined size and ejects the detected plastics in a downward trajectory. In one example, sorted plastics smaller than 3 inches are ejected in a downward trajectory. In another example, sorted plastics from about 3 inches to about 7 inches are ejected in a downward trajectory. Output stream 154b comprising ejected plastics of the predetermined size are mixed with output stream 142b, and then transported to bunker 160 for storage.

Another set of cascading optical sorters is used to sort plastics of different colors and sizes from output stream 130a from de-stoner 130. Optical sorter 146 detects and removes all high density polyethylene (HDPE) color plastics from output stream 130a. In one embodiment, optical sorter 146 is capable of detecting HDPE color plastics on a four feet wide conveyor. Output stream 146a comprising ejected HDPE color plastics are mixed with output stream 142a, which is then transferred to bunker 144 for storage. In the remaining plastics, optical sorter 146 detects plastics of a predetermined size and ejects the detected plastics in a downward trajectory. In one example, sorted plastics smaller than 3 inches are ejected in a downward trajectory. In another example, sorted plastics from about 3 inches to about 7 inches are ejected in a downward trajectory. Output stream 146b comprising ejected plastics of the predetermined size are mixed with output stream 142b, which is then transported to bunker 160 for storage. Output stream 146c comprising all remaining plastics larger than the predetermined size are provided as input to optical sorter 152.

Optical sorter 152 detects and removes all high polyethylene terepthalate (PET) plastics from output stream 146c. In one embodiment, optical sorter 152 is capable of detecting PET on a four feet wide conveyor. Output stream 152a comprising ejected PET plastics are mixed with output stream 148a, which is then transferred to bunker 150 for storage. In the remaining plastics, optical sorter 152 detects plastics of a predetermined size and ejects the detected plastics in a downward trajectory. In one example, sorted plastics smaller than 3 inches are ejected in a downward trajectory. In another example, sorted plastics from about 3 inches to about 7 inches are ejected in a downward trajectory. Output stream 152b comprising ejected plastics of the predetermined size are mixed with output stream 142b, which is then transported to bunker 160 for storage. Output stream 152c comprising all remaining plastics larger than the predetermined size are provided as input to optical sorter 158.

Optical sorter 158 detects and removes all high density polyethylene (HDPE) natural plastics from output stream 152c. In one embodiment, optical sorter 158 is capable of detecting HDPE natural plastics on a four feet wide conveyor. Output stream 158a comprising ejected HDPE natural plastics are mixed with output stream 154a, which is then transferred to bunker 156 for storage. In the remaining plastics, optical sorter 158 detects plastics of a predetermined size and ejects the detected plastics in a downward trajectory. In one example, sorted plastics smaller than 3 inches are ejected in a downward trajectory. In another example, sorted plastics from about 3 inches to about 7 inches are ejected in a downward trajectory. Output stream 158b comprising ejected plastics of the predetermined size are re-sorted by mixing with output stream 130a, which is then provided as input to optical sorter 146. Output stream 158c comprising all remaining plastics larger than the predetermined size are provided as input to eddy current separator 162.

Eddy current separator 162 separates the non-ferrous metals from output stream 158c. An eddy current separator includes spinning magnets that eject non-ferrous metals—such as aluminum—off the conveyor. The separator injects the non-ferrous material with the same charge that small magnets in the drum carry. Like charges repel, and the non-ferrous material bounce off the magnets into a chute. Output stream 162a comprising sorted non-ferrous material is transported to bunker 164 for storage. Remaining materials from eddy current separator 166 are disposed as residue in bunker 166. Although not shown, an additional de-stoner, such as de-stoner 130, can be included after eddy current separator 166 to separate generally light material from generally heavy material. Also, the residue remaining after the various separation operations can be recirculated through process 100 to increase the amount of material diverted to the bunkers. The techniques, devices, and systems described in U.S. patent application Ser. No. 11/883,758, filed May 27, 2008, entitled Systems And Methods For Sorting Recyclables At A Material Recovery Facility, U.S. patent application Ser. No. 11/487,372, filed Jul. 17, 2006, entitled Systems And Methods For Sorting Recyclables At A Material Recovery Facility, U.S. patent application Ser. No. 11/106,634, filed Apr. 15, 2005, entitled Systems And Methods For Sorting, Collecting Data Pertaining To And Certifying Recyclables At A Material Recovery Facility, now U.S. Pat. No. 7,341,156, issued Mar. 11, 2008, U.S. patent application Ser. No. 11/802,497, filed May 23, 2007, entitled Systems And Methods For Optimizing A Single-Stream Materials Recovery Facility, all incorporated by reference herein, can be used in addition to or in combination with the sorting and separation techniques set forth above.

Depending on market needs and economics, sorted material in each bunker discussed above are either baled for resale to recycling facilities, or may be further processed as engineered feed stock to produce fuel. Sorted wastes may generally be classified as fibers, plastics, fats/oils/grease (FOG), and sludge. Each of these classes of sorted wastes may be used to produce engineered feed stock having a predetermined composition to achieve a desired output from a chemical conversion operation. Desired outputs can include one or many aspects of the product of the chemical conversion operation. For example, desired outputs include, but are not limited to, total quantity of material produced by the operation, the quantity of a particular material present in the entire output from the operation, the ratio of particular materials produced by the operation, the quantity of certain impurities in the entire output from the operation, and the higher heating value of the material produced by the operation.

Illustrative techniques and systems for processing sorted and separated waste as feed stock for chemical conversion operations are set forth in U.S. patent application Ser. Nos. 12/491,650, 12/492,096, and 12/492,093 incorporated above. For example, U.S. patent application Ser. No. 12/491,650 describes employing gasification as a chemical conversion operation. Engineered feed stock may then be, for example, used in the gasification unit to convert the feed stock into synthesis gas (syngas). Syngas may then be used in boilers to produce steam to run turbines or maybe used in a Fischer-Tropsch process to produce fuel.

FIG. 2 illustrates an exemplary method 200 of segregating a product that has been optically tagged. At step 210, a product is illuminated with light containing certain wavelengths. This can take place, for example, on a moving conveyor. In such an implementation, the mixed waste stream is spread onto an eight feet wide conveyor. One or more lights are placed in proximity to the surface of the moving conveyor so that the items in the mixed waste stream are exposed to the light as the items move past the lights. At step 220, if any products in the waste stream have been optically tagged, light reflected or emitted by the tagged products is collected by, e.g., cameras or optical sensors that are sensitive to predetermined wavelengths of light. The reflected or emitted light is analyzed to determine its constituent wavelengths at step 230. At step 240, material information associated with the wavelengths of light collected can be retrieved from a database that contains an association between the predetermined wavelengths and the material information. This association can be provided by a manufacturer of a product that is known to contain hazardous materials, or a product that contains multiple materials, and which, therefore, does not belong in a bunker designated for materials of only a specific type.

At step 250, the material information associated with the wavelengths of light reflected or emitted from the product is compared to a list of materials that have been designated as associated with products that are desirous to segregate. If the product is identified as being desirous to segregate based on its material information, the product is segregated from the waste stream at step 260. For example, the one or more cameras can locate the product to be segregated on the moving conveyor, and a jet of air is aimed to hit the product at the location, which removes the product from the conveyor. For products that cannot be removed from the conveyor by the jet of air, the conveyor can be equipped with an arm or other such mechanism that swings into the path of the product to remove it from the conveyor. Optionally, at step 270, notification that a product has been segregated can be sent.

As set forth above, in certain embodiments, a database can be provided that contains an association between predetermined wavelengths and material information (step 240). The database is populated with information from, e.g., manufacturers, distributors, and/or suppliers of products that are likely to enter the waste stream. In one implementation, a range of predetermined wavelengths of light is associated with all products of a certain type in the database. For example, batteries for small consumer electronic devices (e.g., AA, AAA, and/or 9V batteries) are coated with an agent that appears transparent in the visible spectrum while reflecting a particular range of wavelengths in the ultraviolet spectrum. Meanwhile, the plastic exterior shell of smoke detectors (which contain small amounts of radioactive material) are impregnated with a pigment that reflects a range of wavelengths in the ultraviolet spectrum that differs from that of the batteries. In this way, batteries and smoke detectors can not only be removed from the mixed waste stream, but can also be segregated from each other.

In an alternate implementation, all products that are to be removed from the mixed waste stream for segregation are treated with an agent that reflects the same range of wavelengths of light. Thus, although the products cannot be distinguished from each other on the basis of the reflected or emitted light, all of the products can be differentiated from the remaining mixed waste stream.

The associations described above can be supplied to operators of waste sorting and separation processes by manufacturers, distributors, suppliers of products that are likely to enter the waste stream, and/or suppliers of materials for such products. These associations can be supplied in periodic bulk data transfers from the product suppliers by, for example, an Internet upload to the database. In the alternative, a system of associations between product types, materials, and tagging agents can be established in advance of the production and distribution of the products. Aspects of the invention include a hierarchy of tags that identify a wide range of products based on their materials of construction and/or the materials contained therein. This hierarchy can be implemented as a tagging “standard” to be used by product and/or packaging manufacturers, distributors, and/or retailers as well as waste haulers, recycling facilities, and/or other waste handing operations. Thus, aspects of the invention include an “end-to-end” system for the management of tagged products that enables the products to be identified, sorted, separated, recycled, and/or put to another beneficial use after the products have been discarded. While not exhaustive, the following is an illustrative list of the types of products and/or materials that can be tagged in the manner described herein: smoke detectors, small electronics batteries, automotive batteries, used diapers, personal digital assistants, small electronic devices, mobile telephones, thermostats or other device that contain mercury or other toxic materials, gypsum, computer components, ceramics, utensils, lighters, propane tanks, aerosols, and paint cans. Removal of these and other products and materials enables the creation of an optimum fuel from mixed waste streams while avoiding the inclusion of hazardous and other problematic materials. It is noted, however, that materials other than those considered problematic can be tagged as described above. Thus, different types of plastics, for example, can be separated by tagging products made of the plastics accordingly. Likewise, products containing valuable materials, such as precious metals, can be tagged, identified, and segregated.

While the embodiments above are described as enabling the creation of an optimum fuel for incineration and/or gasification with reduced contaminates, the tagging, identification, and sorting techniques described herein enable the separation and sorting of products and materials for other ends. For example, certain embodiments enable the sorting and separation of tagged recyclable materials and products from a mixed waste stream. Similarly, other embodiments can be used to strip a particular type of material, contained in products that have been tagged, from a mixed waste stream.

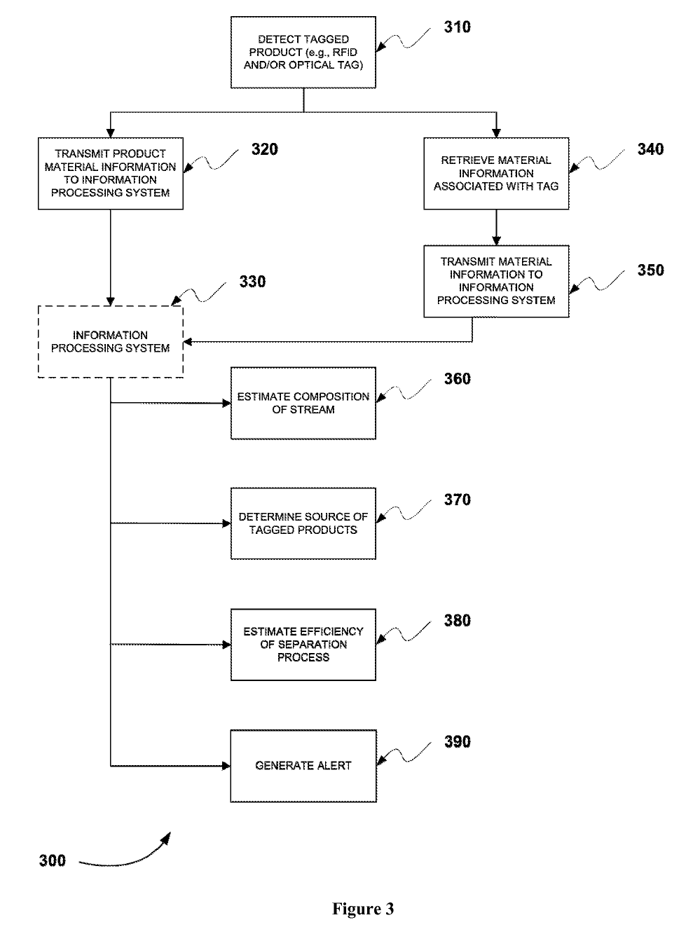

As set forth generally above, embodiments of the invention can be used to identify tagged products for reporting and/or information processing purposes without the need to separate those products. FIG. 3 illustrates an exemplary method 300 for detecting tagged products in a heterogeneous product stream and generating information related to the composition of the stream based on the detected products. At step 310, tagged products are detected according to the techniques described above (e.g., based on an optical tag.) At step 320, information regarding the detected tags (e.g., wavelengths of light reflected or emitted) is transmitted to an information processing system 330.

The information processing system 330 is any system capable of receiving information from multiple information sources, including the material information associated with products, and processing that information to generate reports and other data based on the information. Such systems are known in the art and include, for example, a client/server computer database system. The information processing system 330 can communicate with the tag reading equipment, and other equipment, via wired or wireless networking techniques known in the art. Similarly, the information processing system 330 can generate and communicate reports, processing results, and other data via methods known in the art, e.g., electronic messages, printed reports, and visual information displays.

At step 340, material information associated with the detected tag is retrieved from an information source, such as a database, that contains an association between the tag and the material information. As described in connection with FIG. 2, such a database may be provided by the manufacturer of tagged products or may be populated with information supplied by such manufacturers. The material information that is retrieved is transmitted to the information processing system 330 (step 350).

Once information processing system 330 has the material information associated with the tagged products that have been detected, a number of reports, process results, and other data may be extracted from the information processing system 330. Illustrative examples of information processing results that can be provided by system 330 are as follows, it being understood that other results are within the scope of the invention. At 360, the system 330 can estimate the composition of the waste stream that is being monitored. In one implementation, the tag, or information associated with the tag, contains the material of construction of the tagged product and the product's mass. Given this information, and the total mass of the mixed waste stream, system 330 can estimate the approximate proportions of certain materials in the mixed stream.

Such information can be used to generate performance or compliance reports on generators of the mixed waste streams. For example, if a particular institution generates a mixed stream of waste that is not permitted to contain a certain product, then all products of the prohibited type can be tagged. Upon collection and processing of the mixed waste stream, the stream is scanned for such tagged products. A compliance report containing the presence of any prohibited products can then be generated. Similarly, if particular products are considered valuable, e.g., recyclable products, then a report on the amount of the valuable products can be generated so as to credit the generator of the waste stream.

At 370, the system 330 can determine the source (e.g., manufacturer, distributor, geographic region, etc.) of the tagged products based on information contained within the tag or associated with the tag. Based on this information, products from a particular source can be collected and returned to the source. In addition, in the case of certain recyclable containers, because the source of the product is known, any redemption deposit paid when the container is purchased can be collected from the source upon recovery of the recyclable container from the mixed waste stream.

At 380, the system 330 can estimate the efficiency of a materials sorting and separation process. With reference to sorting and separation process 100, by placing tagged product identification stations and tagged product segregation stations at various locations throughout the process, the type and quantity of tagged products that are present in the various intermediate streams (e.g., 112b, 114a, 114b, 116a, 116b-c, etc.) can be determined. By comparing the composition of a stream entering and exiting a particular separation station, the efficiency or effectiveness of the separation station can be estimated. Moreover, by detecting tagged products on the tipping floor 102 with tagged product identification stations 101 and detecting the tagged products as they enter the product bunkers (e.g., bunkers 106, 109, 120, etc.) with other tagged product identification stations (not shown), the overall efficiency of the separation process can be estimated.

At 390, the information processing system 330 can generate an alert if a particular tagged product or type of tagged product is detected by a tagged product identification station or a tagged product segregation station. Upon the generation of an alert, one or more actions can be taken relative to the tagged product. For example, if a tagged product is detected in a load of mixed waste items, the entire load can be segregated for special treatment. In certain embodiments, a tagged product identification station is located outside of the sorting and separation process 100. For example, an identification station can be located at the source of the generation of mixed waste items. In this way, if a particular tagged product or type of tagged product is detected as it enters a mixed load of waste items at the source, the tagged product can be removed rather than allow it to contaminate an entire load of mixed waste items. In addition, if a tagged product was detected as it entered the mixed waste load, the load can be designated for special treatment, or the load can be refused by the waste hauler. Similar results can be obtained by locating a tagged product identification station on a vehicle that picks-up mixed waste loads.

In addition to using the tags described herein to identify, separate, and/or sort products and/or their components, the tags can be used to validate the proper composition or assembly of a product. For example, a particular product is composed of two different plastic resins. Each plastic resin is optically tagged with an agent so as to reflect or emit different wavelengths of light. Thus, the two different resins can be distinguished from each other by their tags. As the two plastic resins are combined to make the product, the tagging agents included therein imbue the product with a unique optical signature. The optical signature can be, for example, a new wavelength of light provided by the interaction of the various agents. The optical signature can also be a collection of light emissions or reflections that is associated with each of the individual agents included in the combined product. The signature resulting from a product that is known to have been produced correctly is then designated as a “standard” signature for that product. The optical signatures of later produced products are then compared against the standard to validate that the products have been manufactured correctly.

For complex products that can be disassembled into individual components (which are considered products also, as set forth above), aspects of the invention can also be used to verify that the complex product has been completely disassembled. After a complex product has undergone a disassembly process, the individual components are scanned with tag readers to ensure that each component has been separated from every other component. In this way, embodiments of the invention provide for methods and systems for processing complex products contained in a mixed waste stream so as to maximize the amount of material that is recovered for beneficial reuse.

As stated above, embodiments of the invention are useful for separating and sorting products in a mixed waste stream for formulation into a feedstock for a gasification process and eventual production of engineered fuels. As set forth in more detail in the incorporated applications, after mixed materials have been separated based on a number of criteria, the material is recombined in predetermined ratios and further processed to produce the gasification feedstock. In certain embodiments of the invention, optical tags already present in the separated materials are used to validate that a desired feedstock composition has been obtained, as described above. For example, the optical tags included in the material used to make the feedstock will imbue the feedstock material with a specific optical “fingerprint”. By monitoring the optical fingerprint of the feedstock during its production, aspects of the invention allow for validation that the feedstock is being prepared according to the predetermined ratios of materials.

Parts of the techniques and systems disclosed herein may be implemented as a computer program product for use with a computer system. Such implementations may include a series of computer instructions, or logic, fixed either on a tangible medium, such as a computer readable medium (e.g., a diskette, CD-ROM, ROM, flash memory or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., microwave, infrared or other transmission techniques). The series of computer instructions can embody all or part of the functionality described herein with respect to the system. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

It is thought that the waste product segregation system, information processing system, method of the present invention, and many of its attendant advantages will be understood from the foregoing description. It will be apparent that various changes may be made in the form, construction, and/or the arrangement of parts thereof without departing from the spirit and scope of the invention or sacrificing all of its material advantages; the form hereinbefore described being merely a preferred or exemplary embodiment thereof.

What is claimed is:

1. A method of estimating a composition of a heterogeneous mix of products, comprising:
receiving a heterogeneous mix of products including a plurality of types of products, each product containing a corresponding at least one material, wherein at least a plurality of the products each include a product tag associated with information about the product, the information including at least information describing the corresponding at least one material;
scanning the mix of products to detect the tags included with the plurality of products;
retrieving the information describing the corresponding at least one material of the products that include tags detected during the scanning of said mix; and
estimating a total quantity of a selected material present in the heterogeneous mix of products based on the retrieved information describing the corresponding at least one material of the products that include tags detected during the scanning of said mix.

2. The method of claim 1, further comprising estimating the composition of the heterogeneous mix of products based on the information describing the corresponding at least one material of the products including the detected tags.

3. The method of claim 1, further comprising:
subsequent to scanning the mix of products, processing the heterogeneous mix of products in a sorting system, wherein at least a portion of the products are separated from the heterogeneous mix of products;
subsequent to separating the at least a portion of the products from the heterogeneous mix of products, scanning said separated portion to detect the tags included with the products of said separated portion;
retrieving the information describing the corresponding at least one material of the products that include tags detected during the subsequent scanning of said separated portion;
estimating a second quantity of the selected material present in said separated portion based on said retrieved information describing the corresponding at least one material of the products that include tags detected during the subsequent scanning of said separated portion.

4. The method of claim 3, further comprising estimating a measure of separation efficiency based on the estimated total quantity of the selected material present in the heterogeneous mix and the estimated second quantity of the selected material present in said separated portion.

5. The method of claim 1, wherein the product tag includes a compound that reflects light of a predetermined range of wavelengths when exposed to a light source.

6. The method of claim 1, wherein the product tag includes a compound that emits light of a predetermined range of wavelengths when exposed to a light source.

7. A method of sorting a heterogeneous mix of products, comprising:
receiving a heterogeneous mix of products, wherein at least a plurality of the products each include a product tag associated with information about the product, wherein the product tag includes a compound that emits light of a predetermined range of wavelengths when exposed to a light source;
scanning the mix of products to detect the tags included with the plurality of products; and
sorting at least a portion of the plurality of products based on at least one of the product tags and information associated with the tags.

8. The method of claim 7, further comprising:
providing a catalog of tags, each tag being associated with a corresponding material type; and
for each detected tag, retrieving from the catalog the material type corresponding to the detected tag;
wherein the sorting at least a portion of the plurality of products is based on the material types corresponding to the detected tags.

9. The method of claim 7, wherein the emitted light of the predetermined range of wavelengths is reflected light.

10. The method of claim 7, wherein the compound includes a dye that is substantially invisible under ambient light and fluorescent in the visible spectrum under near ultraviolet radiation.

11. The method of claim 7, wherein each product contains a corresponding at least one material, and wherein the information about the product includes at least information describing the corresponding at least one material, and further comprising generating an alert based upon the detection of a product tag associated with a product containing a specified at least one material.

12. The method of claim 7, wherein each product contains a corresponding at least one material, wherein the information about the product includes at least information describing the corresponding at least one material, and wherein the sorting at least a portion of the plurality of products is based on information describing the corresponding at least one material associated with the detected tags.

13. The method of claim 12, wherein the information describing the corresponding at least one material identifies the material as non-homogenous.

14. The method of claim 7, wherein the information about the product includes at least information describing a source of the product, and further comprising estimating a quantity of sorted products from a selected source based on the information describing sources of the products associated with tags included in products of the sorted portion.

15. The method of claim 7, wherein at least one of the products comprises more than one separable component, each component including a component tag, and wherein the sorting at least a portion of the plurality of products is based on detecting more than one component tag included in a product.

16. A method of tagging material for use in making products, comprising:
receiving a heterogeneous mix of products, each product containing a corresponding at least one material;
sorting at least a portion of the plurality of products into groups based on the corresponding at least one material contained in the products, each group having products that include a predetermined material;
mixing a tagging agent with at least one of the groups of sorted products based on the predetermined material of the group so that the tagging agent distinguishes the material contained in the products of the at least one group from other materials.

17. The method of claim 16, further comprising processing the mixture of products of the at least one group and tagging agent to create a tagged recycled material.

18. The method of claim 17, wherein the processing includes shredding the products of the at least one group.

19. The method of claim 16, wherein the tagging agent includes a compound that emits light of a predetermined range of wavelengths when exposed to a light source.

20. The method of claim 19, wherein the emitted light of the predetermined range of wavelengths is reflected light.

21. The method of claim 19, wherein the compound includes a dye that is substantially invisible under ambient light and fluorescent in the visible spectrum under near ultraviolet radiation.

22. The method of claim 19, further comprising:
providing a catalog of a plurality of tagging agents; and
recording, in the catalog, an association between the predetermined material of the group of sorted products and information identifying the tagging agent mixed with the group of sorted products.

23. The method of claim 22, wherein the information identifying the tagging agent includes a predetermined range of wavelengths emitted by the tagging agent when exposed to a light source.

24. A method of determining the composition of a product, comprising:
receiving a product, wherein the product includes more than one component, each component having a component tag identifying the component;
scanning the product to detect the component tags included in the product;
retrieving information describing the components associated with the detected tags; and
estimating the composition of the product based on the information describing the components associated with the detected tags.

25. The method of claim 24, wherein at least one of the component tags includes a compound that emits light of a predetermined range of wavelengths when exposed to a light source.

26. The method of claim 25, wherein each of a plurality of the component tags includes a compound that emits light of a predetermined range of wavelengths when exposed to a light source, the compound included in each component tag emitting a corresponding range of wavelengths differing from the ranges of wavelengths emitted by the compounds included in other component tags of said plurality.

27. The method of claim 26, wherein the scanning the product to detect component tags includes detecting a set of ranges of wavelengths of light emitted by the plurality of the component tags and wherein the information describing the components associated with the detected tags is composition information associated with the set of ranges of wavelengths of light emitted by the plurality of the component tags.

28. The method of claim 26, wherein the scanning the product to detect component tags includes detecting a range of wavelengths of light emitted by a combination of the compounds included in the plurality of component tags.

29. The method of claim 28, the range of wavelengths of light emitted by said combination including wavelengths not included in the ranges of wavelengths of light emitted by the individual compounds alone.
